(19) United States
(12) Patent Application Publication
(10) Pub. No.: US 2009/0106548 A1
(43) Pub. Date: Apr. 23, 2009

(54) METHOD FOR CONTROLLING SECURED TRANSACTIONS USING A SINGLE PHYSICAL DEVICE, CORRESPONDING PHYSICAL DEVICE, SYSTEM AND COMPUTER PROGRAM

(75) Inventors: David Arditti, Clamart (FR); Laurent Frisch, Paris (FR); Herve Sibert, Le Mans (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: France Telecom, Paris (FR)

(21) Appl. No.: 11/996,181

(22) PCT Filed: Jul. 18, 2006
(86) PCT No.: PCT/EP2006/064383

§ 371 Date: Jul. 28, 2008

(30) Foreign Application Priority Data
Jul. 26, 2005 (FR) 0507990

(51) Int. Cl. H04L 9/32

(52) U.S. Cl. 713/156

(57) ABSTRACT

A method is provided for controlling secure transactions using a physical device held by a user and bearing at least one pair of asymmetric keys, including a device public key and a corresponding device private key. The method includes, prior to implementing the physical device, certifying the device public key with a first certification key of a particular certifying authority, delivering a device certificate after verifying that the device private key is housed in a tamper-proof zone of the physical device; verifying the device certificate by a second certification key corresponding to the first certification key; and in case of a positive verification, registering the user with a provider delivering a provider certificate corresponding to the signature by the provider of the device public key and an identifier of the user.

### CROSS-REFERENCE TO RELATED APPLICATIONS

This Application is a Section 371 National Stage Application of International Application No. PCT/EP2006/064383, filed Jul. 18, 2006 and published as WO 2007/012583 A1 on Feb. 1, 2007, not in English.

### FIELD OF THE DISCLOSURE

The field of the disclosure is that of the securing of electronic transactions, implementing especially authentication, electronic signing and payment operations performed by means of communications networks such as the Internet for example.

More specifically, the disclosure relates to a technique for the control of secured transactions bringing into play a physical device that is in the possession of a user.

### BACKGROUND OF THE DISCLOSURE

The strong growth of communications networks such as the Internet for example and the constant increase in the number of daily transactions on these networks has given rise to a constantly increasing need for the securing of transactions. Indeed, it has been seen to be necessary that the environment of trust surrounding physical exchanges by conventional mail or by direct contact should be reproduced in these information technology or radio communications networks.

In the prior art, a certificate is used in particular to verify the validity of a public cryptographic key used in a computer network. This certificate is a message comprising at least a public key, an identifier of its holder, a period of validity, an identification of a certifying authority and a cryptographic signature of these different pieces of data, obtained by means of the secret key of this certification authority that has issued the certificate.

The reading of the certificate enables the authentication with certainty of the sender of a message received in the case of the signature and of the identifier of the entity authenticating itself in the case of authentication.

For further information on the certificate, reference may be made especially to the standard X.509, and more particularly X.509v3 defined in the RFC3280 (Request For Comment n^{o}3280) published by the IETF (Internet Engineering Task Force).

One drawback of the prior art technique referred to here above is that it does not enable a provider to make sure simply, and remotely, that the provider certificate Cᵢ issued by it truly certifies a public key P₀ corresponding to a private key S₀ stored in a given physical device.

Indeed, the behavior of a physical device may be totally simulated by a software program so that it is impossible for the provider to know remotely if it corresponds to a physical device or else to a software emulation of such a device.

Now, there are several circumstances in which it is important for a provider to have proof that he is communicating with a genuine physical device.

Indeed, if the private key S₀ of the physical device remains stored, in accordance with the good practice, in a secret and inaccessible zone, the physical device cannot be cloned and is therefore a unique object which alone is capable of producing the authenticators and signatures corresponding to the public key P₀, and hence to the certificate Cᵢ, and hence also to the identifier Idᵢ by which the customer is known to the i^{th} provider. Only the possessor of the physical device can then authenticate himself or sign with the identifier Idᵢ with respect to the i^{th} provider. This constitutes a strong property of non-repudiation, a pledge of security for the provider.

Another circumstance in which it is important for the provider to be able to make sure that he is dealing with a given physical device is when this physical device is the medium of a paid subscription to a service provided by the provider (for example access on the Internet to newspaper articles published in a daily newspaper). Access to the paid service is conditional, for the user, on the opening of a session with the provider during which he authenticates himself by means of his physical device.

It is therefore particularly important for the provider to make sure that the customer who wishes to access the service is truly in possession of the physical device in order to prevent several persons from being able to access the service (simultaneously or otherwise) in paying only one subscription. This would be the case if the subscription medium could be cloned (for example if the subscription medium were to be an “identifier/password” set or a private key (even enciphered) stored in a hard disk drive).

The French patent application FR 96 08692 entitled “Procédé de contrôle de transactions sécurisées indépendantes utilisant un dispositif physique unique” (Method for the control of independent secured transactions using a single physical device), filed on behalf of the applicant of the present patent application provides a more particular description of a physical device of this kind used to perform authentication with one or more providers, with whom the user of the device wishes to carry out a transaction.

In this method, the users are provided with physical devices such as chip cards or USB (universal serial bus) dongles which are classically associated with a pair of asymmetric keys (P₀, S₀) comprising one private key S₀ and one public key P₀. The private key S₀ is an electronic element that must remain secret and is therefore stored in a protected space of the physical device, sheltered from any attempt at intrusion. The public key P₀ for its part can be stored in a freely read-accessible state in the physical device or it may be delivered to the user on an external carrier such as a floppy disk, a CD-Rom, a paper document or a reserved space in a data server. This pair of keys (S₀, P₀) is created in the factory, prior to the commercial distribution and commissioning of the device.

A physical device of this kind also classically comprises computation means to perform an authentication and/or signature asymmetric cryptographic algorithm. Among these algorithms, we may cite algorithms of the RSA (Rivest-Shamir-Adleman), DSA, GQ (Guillou-Quisquater) or GPS type for example.

The use of this asymmetric cryptographic algorithm may be subject to the prior presentation of a carrier code (or PIN (personal identification number) code) initialized in a phase of pre-personalization of the physical device, and managed according to classic techniques which are not the object of the present patent application.

The physical device can then be sold in this form to a user by means of a distribution means independent of any provider.

To enable the performance of a secured transaction (authentication, signature) with a provider, the user of the physical device, also called a customer, must obtain issuance, from the provider, of a certificate C₁ linking the public key P₀ of the device and an identifier Id₁ relevant to the provider (note: in systems where the anonymity of the user relative to the provider must be preserved, the identifier Id₁ is different from the user's civil identity).

This operation commonly called “registration” can be done with n distinct providers, so that the customer is assigned n certificates {C₁, C₂, . . . , Cₙ} linking n identifiers {Id₁, Id₂, . . . , Idₙ} (each of them being relevant to a given provider) to the same public key P₀.

When the customer thereafter wishes to make a secured transaction with the i^{th} provider, he uses his physical device to sign a random value sent by the provider (the term used then is authentication) or a message (the term used then is electronic signing) using his secret key Sᵢ and associating thereto the corresponding certificate Cᵢ given by the certification authority according to standardized protocols.

According to the prior art, the only method by which a provider can make sure that the transaction in progress is being actually done by means of a given physical device relies on the physical handling of the device by the provider. Indeed, he or it can then read the public key P₀ in the device for himself or itself, should it be stored therein. If this is not the case, he or it can make the device sign a random value by means of the secret key S₀, and then verify the result of this signature by means of the public key P₀ given by the customer on an external carrier.

However, one drawback of this prior art approach is that it requires the provider to be capable of physically operating on the device, and therefore excludes any remote action. This can be problematic in the context of transactions performed in modern communications networks such as the Internet.

### SUMMARY

An aspect of the present disclosure relates to a method for the control of secured transactions implementing a physical device held by a user and bearing at least one pair of asymmetric keys, comprising a device public key (P₀) and a corresponding device private key (S₀).

According to an embodiment of the invention, a control method of this kind comprises the following steps:
prior to the commissioning of said physical device, a first step of certifying said device public key (P₀) by signing with a first certification key (S_{T}) of a particular certification authority (ACP), issuing a device certificate (C₀), after verification that said device private key S₀ is housed in a tamper-proof zone of said physical device (13);
a step of verification of said device certificate (C₀) by means of a second certification key (P_{T}) corresponding to said first certification key (S_{T});
in the event of positive verification, a step for the registering of said user with a provider issuing a provider certificate (Cᵢ) corresponding to the signing by said provider of said device public key (P₀) and of an identifier (Idᵢ) of this user.

Thus an embodiment of the invention relies on a wholly novel and inventive approach to the securing of electronic transactions. Indeed, in order to introduce an additional degree of securitization, the technique of an embodiment of the invention brings into play a particular certification authority (ACP) in which the different providers place their trust. This particular certification authority, prior to the commissioning of the physical device (USB dongle, chip card etc), issues a certificate pertaining to this physical device (and not as in the prior art a certificate pertaining to an identifier of its holder), the verification of the validity of which is a guarantee, for the provider, that even remotely he or it is in the presence of a real physical device and not a piece of equipment (computer, PDA etc) that would be fraudulently reproducing its behavior.

This securitization relies on a strong commitment, on the part of the particular certification authority, that it will not produce such device certificates C₀ from a first certification key S_{T}, except for the public keys P₀ corresponding to private keys S₀ stored in a given physical device.

The verification of the device certificate can be done directly by the provider, from a second certification key of the particular certification authority which this authority will have communicated to it, or by a trusted third party. Thus, the transaction control method of an embodiment of the invention uses the undertaking of the ACP to provide assurance to a provider that the customer who wishes to enter into a secured transaction truly possesses a physical device which has been certified by the ACP. Thus, there is a sharp distinction with respect to the prior art which does not provide any assurance, remotely, that the user possesses a physical device. Indeed, the control techniques of the prior art ensure only the identification of the user, if need be by means of a stringing of authentications and certifications based on the use of a succession of certification authorities, but always have only one consequence which is the certification of the identity of a user. In addition to the certification of the user's identity, the method of an embodiment of the invention comprises the preliminary certification of the physical device subsequently held by this user. This makes it possible to provide assurance to a provider, possibly at a distance, that the user who authenticates himself with this provider possesses a physical device. Only this assurance enables the setting up of the transaction control process to be continued.

When assured of the validity of the device certificate C₀, the provider can then proceed in a classic manner to the registration of the user to whom it will issue a provider certificate Cᵢ.

Preferably, said particular certification authority is a manufacturer of said physical device, who can then issue the device certificate C₀, directly when the device leaves the production lines. The particular certification authority can also be a third-party certification authority working for one or more distinct manufacturers.

Advantageously, said device certificate (C₀) is stored in a freely read-accessible memory zone of said physical device. It can thus be easily read by the provider.

According to an advantageous characteristic of an embodiment of the invention said device certificate (C₀) also signs at least one piece of information representing said physical device, that belongs to the group comprising the following pieces of information:
type of physical device;
identification of the manufacturer of said physical device;
type of cryptographic algorithm used by said physical device;
serial number of said physical device.

During the verification of the device certificate C₀, the provider thus has additional information available on the physical device that he is dealing with, which may enable him for example to verify that the type of device is suited to the nature of the transaction envisaged, or to ensure the traceability of the device on the basis of its serial number.

In an alternative advantageous embodiment of the invention, said verification step is performed by said provider. Thus, the provider knows directly if he can or cannot register the user without having to call on the services of a third-party verification authority (which could also be envisaged in the context of an embodiment of the present invention).

In a first advantageous embodiment, said first certification key (S_{T}) is a private key and said second certification key (P_{T}) is a public key. Thus a pair of asymmetric keys is used, where the private key (S_{T}) is kept secret by the particular certification authority unlike the public key which may be communicated to the providers or published.

In a second advantageous embodiment, said particular certification authority uses a symmetrical key (K), so that said first certification key (S_{T}) and said second certification key (P_{T}) are identical.

In this case, said step of certification is implemented on the basis of said symmetrical key by said particular certification authority upon a request by a manufacturer of said device, and said verification step is implemented by said particular certification authority upon a request by said provider.

Again, this particular certification authority may of course be the manufacturer himself.

An embodiment of the invention also relates to a physical device held by a user and designed to be used during secured transactions, said physical device bearing at least one first pair of asymmetric keys comprising a device public key (P₀) and a corresponding device private key (S₀).

According to an embodiment of the invention, a device of this kind also carries a device certificate C₀, issued after it has been verified that said device private key S₀ is housed in a tamper-proof zone of said physical device (13) corresponding to the signing of said first device public key P₀ by a first certification key S_{T} of a particular certification authority, and said device certificate (C₀) is stored in said physical device prior to its commissioning.

An embodiment of the invention also relates to a computer program product downloadable from a communications network and/or stored on a carrier that is computer-readable and/or executable by a microprocessor, characterized in that it comprises program code instructions to implement at least one step of the method for controlling secured transactions as described here above.

An embodiment of the invention also relates to a system for the controlling of secured transactions in a communications network, implementing a physical device held by a user and bearing at least one pair of asymmetric keys, comprising a device public key P₀ and a corresponding device private key S₀. Such a system comprises at least:
a particular certification server connected to said network, issuing to said physical device, after verification that said device private key S₀ is housed in a tamper-proof zone of said physical device (13) and prior to its commissioning, a device certificate C₀ corresponding to the signing of said device public key P₀ by a first certification key S_{T} of said particular certification server;
a server for the verification of said device certificate C₀ by means of a second certification key P_{T} corresponding to said first certification key S_{T}, said verification server being connected to said network;
a server for the registering of said user with a provider, issuing to said user, in the event of positive verification by said verification server, a provider certificate Cᵢ corresponding to the signing by said provider of said device public key P₀ and of an identifier Idᵢ of said user, said registering server being connected to said network.

### BRIEF DESCRIPTION OF THE DRAWINGS

Other features and advantages shall appear more clearly from the following description of the preferred embodiment, given by way of a simple, non-restrictive illustration, and from the appended drawings of which:

FIG. 1 illustrates the principle of certification, by a particular certification authority, of the public key of a physical device, prior to its commissioning;

FIG. 2 is a block diagram of the different steps implemented in the method of an embodiment of the invention for controlling secured transactions;

FIG. 3 describes the different exchanges between a user and different servers of an embodiment of the invention, through a communications network, in the context of the method of FIG. 2.

### DETAILED DESCRIPTION OF ILLUSTRATIVE EMBODIMENTS

The general principle of an embodiment of the invention is based on the certification of the public key P₀ of a physical device, prior to its commissioning, by a particular certification authority, enabling a provider to be given a guarantee, during a secured transaction (possibly a remote transaction), that he is truly dealing with a genuine physical device in which the corresponding private key S₀ associated with the public key P₀ is stored.

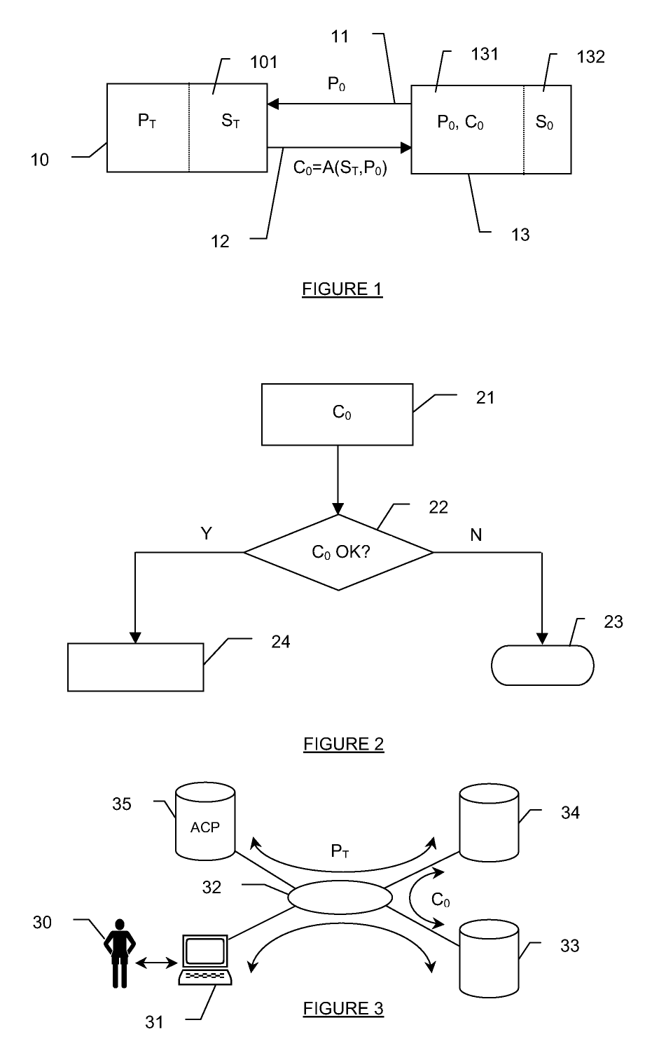

Referring to FIG. 1, an embodiment is presented of the certification of the public key P₀ of a given physical device 13, prior to its commissioning.

A particular certification authority or ACP, 10 has a pair of asymmetric keys (P_{T}, S_{T}) comprising a public key P_{T} and a private key S_{T} kept in a secret and inaccessible zone 101. An ACP 10 of this kind is for example the manufacturer of the physical device: the secret zone 101 in which the private key S_{T} is memorized is then a particular physical device (a chip card for example) held by the manufacturer or a restricted-access protected memory zone of one of his computer installations.

The public key P_{T} for its part is published by the ACP 10, or supplied at the request of one of the potential providers who might have need of it (i.e. providers liable to make transactions with the holder of the physical device 13).

During the manufacture of the physical device 13, a pair of asymmetric keys (P₀, S₀) is recorded therein. This pair of asymmetric keys (P₀, S₀) comprises a public key P₀, stored in a read-accessible zone 131 of the device 13 and a private key S₀ stored in a protected zone 132 of this device 13. This protected or tamper-proof zone 132 is designed so as to prevent the reading of the private key S₀ and resist any attempt at software or hardware intrusion. As a variant, the public key P₀ can also be communicated to the holder of the physical device 13 on an external support, independent of the device itself.

If the ACP 10 is the manufacturer of the physical device 13, the operations illustrated in FIG. 1 are performed before the commercial distribution of the physical device, in the factory, during a phase of (pre-)personalization of the device. If it is a certification authority independent of the manufacturer, these operations may be performed when the physical devices come off the manufacturing lines, before they are distributed to the final users.

More specifically, the physical device 13 communicates 11 its device public key P₀ to the ACP 10. Then, with its private key S_{T}, the ACP 10 signs the public key P₀ of the device 13. This signature 12 constitutes an identity certificate C₀=A(S_{T},P₀) (where A designates a cryptographic signature algorithm of the RSA type for example) which, like the public key of the device P₀ could be written in the physical device 13 in a freely read-accessible zone 131, or given to the user of the device 13 on an external carrier (floppy disk, CD-ROM, paper document etc).

The ACP 10 (manufacturer or trusted third party) naturally undertakes not to produce such device certificates C₀ (i.e. such signatures with its private key S_{T}) except for public keys P₀ corresponding to private keys stored in a given type of physical device.

The certification operations of FIG. 1 may also, in one alternative embodiment of the invention, be mutualized for several manufacturers of different types of physical devices. In this case, the ACP 10 is a trusted third party, independent of all the manufacturers, that holds the private key S_{T}, and, in order to produce the device certificate C₀ of a given physical device 13, signs the pair (P₀, <type of device>) with its private key S_{T}. Such information on <type of device> enables information to be obtained for example on the nature of the device 13, i.e. whether it is a USB dongle, a chip card etc. It may also be the product reference used by the manufacturer to designate one of the devices that he builds.

Similarly, as a variant, other pieces of information relevant to the use of the physical device 13 may be signed into the device certificate C₀, for example information such as the manufacturer's name (<manufacturer's name>), the type of cryptographic algorithm used (<type of algorithm>), the serial number of the device etc.

Thus, during a subsequent phase of verification of the device certificate C₀ by a provider (described here below in greater detail with reference to FIGS. 2 and 3), this provider will have the assurance that the device public key P₀ corresponds to a secret key S₀ stored in a <type of device> type device 13 manufactured by <manufacturer's name>, and using the cryptographic algorithm <type of algorithm>. This assurance results from the trust placed by the provider in the particular certification authority 10.

It can also be imagined, as a variant of the operations illustrated in FIG. 1, that P_{T}=S_{T}=K is a symmetrical key.

In this case, the key K can be shared between the manufacturer of the physical device 13 and one (or a few rare) trusted third parties of whom the manufacturer knows that they will keep this key K secret; in this case, only the third parties or the manufacturer himself would be able to verify the certificate.

It is also possible to envisage a case where the key K is used only by an ACP 10, independent of the manufacturer, that signs the symmetrical key device certificate C₀ solely at the request of the manufacturer of the physical devices 13. Similarly, this ACP 10 will be the only entity capable of verifying the device certificates C₀, at the request of the providers wishing to perform a transaction with the associated physical devices 13. Once again, this APC 10 can of course be the manufacturer himself.

The physical device 13 in which the certificate C₀ has been recorded by the ACP 10 is sold by a distribution means independent of any provider, for example in a big store or by a certified retailer.

Referring now to FIGS. 2 and 3, the way in which the device certificate C₀ is used in the context of a secured transaction between the possessor 30 of the physical device 13 and a provider 33 is presented. Such a provider 33 may, for example, be a provider of services (access to a weather news service or to geolocation service for example) or a vendor of goods (a trader on the Internet for example).

The physical device 13 has been acquired by a user 30 who wishes to use it to access the services proposed by a provider 33 through a communications network 22, for example the worldwide network known as the Internet. A physical device 13 of this kind is used for example as a carrier with a paid subscription service taken by the user 30 with the provider 33 (for example a subscription to a daily horoscope published on the Internet).

When the user 30 wishes to access the services of the provider 33, he sends a request through his communications terminal 31 (for example a computer) conveyed by the communications network 32 to the provider 33. This request is accompanied by the public key P₀ and the device certificate C₀ which has been pre-recorded 21 by the ACB 10 in the physical device 13 (which has not been shown in FIG. 3 for the sake of simplicity).

Before agreeing to the request of the user 30, the provider must verify that the public key P₀ which has been transmitted to him truly corresponds to a secret key S₀ stored in a given physical device. To this end, it carries out a verification 22 of the device certificate C₀ transmitted with the request, by means of the public key P_{T} of the particular certification authority 10.

In the event of negative verification, i.e. if the device certificate C₀ does not correspond to the signing of the public key P₀ of the physical device by the private certification key S_{T} of the ACP 10, the provider 33 can put an end to the transaction and refuse access to the user 30 of the required article or service.

However, in the event of positive verification, the provider acquires certainty that the public key P₀ truly corresponds to a private key S₀ stored in a given physical device 13, and he or it can therefore accept the request of the user 30, in carrying out the registration 24 of this user using a relevant identifier (Idᵢ). To this end, the provider 33 issues a provider certificate Cᵢ to the user 30, corresponding to the signing of the public key P₀ and of said identifier (Idᵢ) by the provider 33. This provider certificate Cᵢ is transmitted to the user's communications terminal 31 through the communications network 32 to which the registration server of the provider 33 is connected.

The verification 22 of the device certificate C₀ can be done by the provider 33 himself or itself, or by a dedicated verification server 24, also connected to the network 32. In this case, the provider 33 transmits the device certificate C₀ to the verification server 34 through the network 32. The certification server 35 of the ACP 10 which had created the device certificate C₀ of the physical device 13, communicates or has communicated its public key P_{T} to the verification server 34. All that the verification server 34 has to do thereafter is to use the public key P_{T} of the certification server 25 to verify the authenticity of the certificate C₀, and then transmit the result of this verification to the provider 33, so that this provider 33 knows whether it can carry out the registration 24 of the user 30 or whether it should bring the exchange in progress to an end 23.

When the registration 24 of the user 30 with the provider has been done, the user can then start carrying out secured transactions with the provider 33: to do so, it uses its physical device 13 to sign a random value given by the provider (the term used in this case is authentication) or a message (the term used here is signature) using its device secret key Sᵢ, and by associating thereto the corresponding device certificate Cᵢ, according to the standard protocols which are not the object of the present patent application and shall therefore not be described herein in greater detail.

The user 30 can then carry out a registration 24 which several different providers who will each issue a distinct provider certificate Cᵢ linking the public key P₀ of the physical device 13 to an identity Idᵢ of the user 30, relevant to the provider considered.

An embodiment of the invention provides a technique for the control of secured transactions implementing a physical device that is associated with a pair of asymmetric keys (P₀, S₀), used to make sure, and if necessary remotely, that a transaction has been actually performed by means of a given physical device.

An embodiment of the invention proposes a technique of this kind that enables a provider to make sure that the public key P₀ that he must certify actually corresponds to a secret key S₀ stored in a given physical device.

An embodiment of the invention proposes a technique of this kind that is simple to implement and introduces little or no additional complexity into the physical devices used.

An embodiment of the invention provides a technique of this kind that is reliable and can be used to obtain a strong property of non-repudiation so as to create an environment of trust for the provider.

Although the present disclosure has been described with reference to one or more examples, workers skilled in the art will recognize that changes may be made in form and detail without departing from the scope of the disclosure and/or the appended claims.

1. Method for the control of secured transactions implementing a physical device held by a user and bearing at least one pair of asymmetric keys, comprising a device public key and a corresponding device private key, wherein the method comprises the following steps:
prior to commissioning said physical device, a first step of certifying said device public key by signing with a first certification key of a particular certification authority, issuing a device certificate, after verification that said device private key is housed in a tamper-proof zone of said physical device;
a step of verification of said device certificate by a second certification key corresponding to said first certification key;
in the event of positive verification, a step of registering said user with a provider issuing a provider certificate corresponding to a signing by said provider of said device public key and of an identifier of this user.

2. Control method according to claim 1, wherein said particular certification authority is a manufacturer of said physical device.

3. Control method according to claim 1, wherein said device certificate is stored in a freely read-accessible memory zone of said physical device.

4. Control method according to claim 1 said device certificate also signs at least one piece of information representing said physical device.

5. Control method according to claim 4, wherein said piece of information representing said physical device belongs to the group comprising the following pieces of information:
type of physical device;
identification of the manufacturer of said physical device;
type of cryptographic algorithm used by said physical device;
serial number of said physical device.

6. Control method according to claim 1, wherein said verification step is performed by said provider.

7. Control method according to claim 1, wherein said first certification key is a private key and said second certification key is a public key.

8. Control method according to claim 1, wherein said particular certification authority uses a symmetrical key, so that said first certification key and said second certification key are identical.

9. Control method according to claim 8, wherein said step of certification is implemented on the basis of said symmetrical key by said particular certification authority upon a request by a manufacturer of said device, and said verification step is implemented by said particular certification authority upon a request by said provider.

10. Physical device held by a user and designed to be used during secured transactions, said physical device bearing at least one first pair of asymmetric keys comprising a device public key and a corresponding device private key wherein the physical device is also associated to a device certificate, issued after it has been verified that said device private key is housed in a tamper-proof zone of said physical device and corresponding to a signing of said first device public key by a first certification key of a particular certification authority, and wherein said device certificate is stored in said physical device prior to its commissioning or provided to the user of said physical device on an external carrier.

11. Computer program product stored on a carrier that is computer-readable and/or executable by a microprocessor, wherein the product comprises program code instructions to implement at least one step of a method for controlling secured transactions implementing a physical device held by a user and bearing at least one pair of asymmetric keys, comprising a device public key and a corresponding device private key, wherein the method comprises:
prior to commissioning said physical device, a first step of certifying said device public key by signing with a first certification key of a particular certification authority, issuing a device certificate, after verification that said device private key is housed in a tamper-proof zone of said physical device;
a step of verification of said device certificate by a second certification key corresponding to said first certification key; and
in the event of positive verification, a step of registering said user with a provider issuing a provider certificate corresponding to a signing by said provider of said device public key and of an identifier of this user.

12. System for the controlling of secured transactions in a communications network, implementing a physical device held by a user and bearing at least one pair of asymmetric keys, comprising a device public key and a corresponding device private key, wherein the system comprises at least:
a particular certification server connected to said network, issuing to said physical device, after verification that said device private key is housed in a tamper-proof zone of said physical device and prior to its commissioning, a device certificate corresponding to a signing of said device public key by a first certification key of said particular certification server;
a server, which verifies said device certificate by a second certification key corresponding to said first certification key, said verification server being connected to said network; and
a server, which registers said user with a provider, issuing to said user, in the event of positive verification by said verification server, a provider certificate corresponding to a signing by said provider of said device public key and of an identifier of said user, said registering server being connected to said network.
